(19) United States
(12) Patent Application Publication
(10) Pub. No.: US 2005/0088794 A1
(43) Pub. Date: Apr. 28, 2005

(54) Removeable ESD for improving I/O pin bandwidth

(75) Inventors: David W. Boerstler, Round Rock, TX (US); Gricell Co, Austin, TX (US); Harm Peter Hofstee, Austin, TX (US); Christopher Stephen Putnam, Hinesburg, VT (US)

Correspondence Address: IBM CORPORATION (CS);C/O CARR LLP, 670 FOUNDERS SQUARE, 900 JACKSON STREET, DALLAS, TX, 75202, US

(73) Assignee: International Business Machines Corporation, Armonk, NY (US)

(21) Appl. No.: 10/692,415

(22) Filed: Oct. 23, 2003

(51) Int. Cl. H02H 5/04

(52) U.S. Cl. 361/103

(57) ABSTRACT

The present invention provides for disconnecting a capacitive path from a device when the capacitive path is no longer needed. Disconnecting a capacitive path when it is no longer needed is beneficial because the existence of a capacitive path limits the speed of the protected device. The device is separated from the capacitive path as a function of the current between the IO pad and a control device.

### TECHNICAL FIELD

The invention relates generally to protecting devices from electrostatic discharge (ESD) and, more particularly, to disconnecting ESD protection after device installation.

### BACKGROUND

In conventional processor designs, protecting devices from electrostatic discharge (ESD) voltage spikes is a significant problem. The problem is particularly pronounced when the devices are being assembled into a larger package. Therefore, ESD protection is installed for sensitive parts of the device. ESD protection works by limiting the voltage at a certain point by tying the sensitive area to a known voltage.

For instance, one method of ESD protection could employ diodes. A diode is either forward or reverse biased. If a diode is forward biased, it conducts. If the diode is reverse biased, it does not conduct. When a diode is forward biased, the voltage on the diode's cathode is less than the voltage on the diode's anode. The difference in voltage required to forward bias a diode is the activation voltage. The activation voltage of a diode is the magnitude of the minimum voltage difference between a diode's anode and its cathode required to forward bias a diode, where the voltage applied to the cathode is lower than the voltage applied to the anode. Since the activation voltage of a diode is usually around 0.6 volts, to forward bias a diode, the voltage on the anode must be at least 0.6 volts higher than the voltage on the cathode.

Diodes could be coupled to an input/output (IO) pad. The anode of a first diode is tied to the cathode of a second. A connection is made between the anode of the first diode and the IO pad. The anode of the second diode is tied to ground, and the cathode of the first diode is tied to the system high voltage (Vdd). When the voltage difference between the IO pad and ground exceeds the activation voltage of the second diode, the second diode becomes forward biased and creates a conducting path from ground to the IO pad. Connecting the IO pad to ground through the second diode protects the input coupled to the IO pad by preventing the magnitude of the voltage difference between ground and the IO pad from exceeding the activation voltage of the second diode. When the voltage difference between the IO pad and Vdd exceeds the activation voltage of the first diode, the first diode becomes forward biased and creates a conducting path from Vdd to the IO pad. Connecting the IO pad to Vdd through the first diode protects the input coupled to the IO pad by preventing the magnitude of the voltage difference between Vdd and the IO pad from exceeding the activation voltage of the first diode.

As the processing speeds of devices have increased, the frequency of voltage oscillations on the IO pad has also increased. As the clock frequency of a device approaches 2 GigaHertz, the capacitance effect of the ESD protection diodes becomes problematic. Coupling the first diode to Vdd and the second to ground creates capacitance when the diodes are reverse biased. Under ordinary circumstances, diodes laid out in series with one another can mitigate the capacitance. Placing the diodes in series does not eliminate the capacitance in this application because the capacitance of the diodes varies non-linearly. Likewise, laying out diodes in parallel merely increases the capacitance effect. Ultimately, the excess capacitance created by the diodes limits the effective signaling speed of the IO pad.

ESD voltage spikes are most likely to occur during the original installation process of the device. Once the devices are embedded into higher level systems, the need for individualized protection declines because the devices can rely upon the ESD protection present at the higher level. However, the capacitance problem inherent in ESD protection still limits processing speeds.

Therefore, a need exists for a method of eliminating the capacitance problem created by ESD protection when integration of the device into a higher level system renders the ESD protection redundant.

### SUMMARY OF THE INVENTION

The present invention provides for separating a capacitive path from an IO pad and protected component. A voltage is applied to an IO pad of a protected component. A current is generated between the IO pad and a control device. The IO pad is separated from the capacitive path as a function of the current between the IO pad and the control device.

### BRIEF DESCRIPTION OF THE DRAWINGS

For a more complete understanding of the present invention, and the advantages thereof, reference is now made to the following Detailed Description taken in conjunction with the accompanying drawings, in which:

FIG. 1 schematically depicts a system for removing ESD protection from a single IO pad by blowing a fuse with a fuse blow pad;

FIG. 2 schematically depicts a system for removing ESD protection from a single IO pad by blowing a fuse with a fuse blow control device;

FIG. 3 schematically depicts a system for removing ESD protection from a single IO pad by blowing two fuses;

FIG. 4 schematically depicts a system for removing ESD protection from multiple IO pads by blowing two fuses; and

FIG. 5 schematically depicts a system for removing ESD protection from multiple IO pads by blowing a single fuse per IO pad.

### DETAILED DESCRIPTION

In the following discussion, numerous specific details are set forth to provide a thorough understanding of the present invention. However, those skilled in the art will appreciate that the present invention may be practiced without such specific details. In other instances, well-known elements have been illustrated in schematic or block diagram form in order not to obscure the present invention in unnecessary detail. Additionally, for the most part, details have been omitted inasmuch as such details are not considered necessary to obtain a complete understanding of the present invention, and are considered to be within the understanding of persons of ordinary skill in the relevant art.

It is further noted that, unless indicated otherwise, all control functions described herein may be performed in either hardware or software, or some combination thereof. In a preferred embodiment, however, the control functions are performed by a processor, such as a computer or an electronic data processor, in accordance with code, such as computer program code, software, and/or integrated circuits that are coded to perform such functions, unless indicated otherwise.

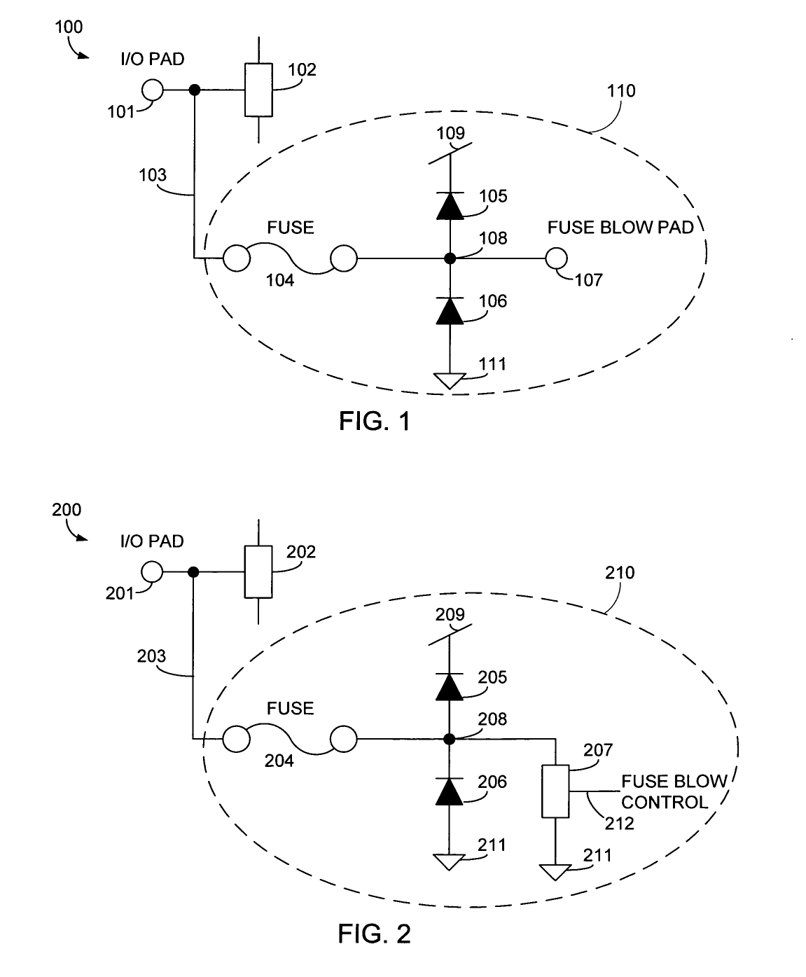

Turning to FIG. 1, disclosed is a system 100 for removing a capacitive path from a single IO pad 101 and protected element (in this case, a processor) 102. The capacitive path is removed by blowing a first circuit which ceases to conduct when exposed to a current (in this case, a fuse) 104. The fuse is coupled to a second circuit able to blow the first circuit in response to variations in voltage (in this case, a fuse blow pad) 107. The system 100 comprises a protected element (in this case, a processor) 102. The processor 102 is coupled to an IO pad 101. The IO pad 101 is coupled to a current conducting path 103.

An ESD protection assembly 110 comprises a fuse 104, a fuse blow pad 107, and a conduction path for ESD protection (in this case, two diodes) 105, 106. The anode of the first diode 105, the cathode of the second diode 106, and the fuse blow pad 107 are each coupled with a node 108. The cathode of the first diode 105 is coupled to global Vdd 109. The anode of the second diode 106 is coupled to ground 111. The ESD protection assembly 110 is coupled to the IO pad 101 and processor 102 via the fuse 104. One end of the fuse 104 is coupled with the current conducting path 103. The other end of the fuse 104 is coupled with the node 108.

In the system 100, the diodes 105, 106 shield the IO pad 101 and processor 102 from variations in voltage that exceed the activation voltage of the diodes 105, 106. When the voltage difference between the IO pad 101 and ground 111 exceeds the activation voltage of the second diode 106 (the activation voltage of the second diode 106 will be exceeded when the ground 111 voltage exceeds the voltage at the IO pad 101 by around 0.6 volts), the second diode 106 becomes forward biased and creates a conducting path from ground 111 to the IO pad 101. Connecting the IO pad 101 to ground 111 protects the input coupled to the IO pad 101 by preventing the magnitude of the voltage difference between ground 111 and the IO pad 101 from exceeding the activation voltage of the second diode 106. Alternatively, when the voltage difference between the IO pad 101 and Vdd 109 exceeds the activation voltage of the first diode 105 (the activation voltage of the first diode 105 will be exceeded when the voltage at the IO pad 101 exceeds Vdd 109 by around 0.6 volts), the first diode 105 becomes forward biased and creates a conducting path from Vdd 109 to the IO pad 101. Connecting the IO pad 101 to Vdd 109 through the first diode 105 protects the input coupled to the IO pad 101 by preventing the magnitude of the voltage difference between Vdd 109 and the IO pad 101 from exceeding the activation voltage of the first diode 105.

In the system 100, the IO pad 101 and processor 102 can be electrically separated from the ESD protection assembly 110 if the fuse 104 is blown. The fuse 104 is blown by applying a voltage to the IO pad 101. Simultaneously, a voltage applied to the fuse blow pad 107 varies from the voltage at the IO pad 101, but not so that the difference in voltages exceeds the activation voltage of either the first diode 105 or the second diode 106. When these two diodes 105, 106 are not forward biased, a current sufficient to blow the fuse 104 is created between the IO pad 101 and the fuse blow pad 107. Blowing the fuse 104 decouples the processor 102 and IO pad 101 from the troublesome capacitance created by the ESD protection assembly 110.

Although the system 100 of FIG. 1 illustrates the invention using diodes and fuses, those of skill in the art understand that other elements are within the scope of the present invention.

In a further embodiment, laser fuses are employed. Laser fuses can be generally defined as a conductive path which is made non-conductive by laser ablation, melting or otherwise vaporizing a section of the conduction path by an external laser so that the conductive path no longer conducts. The conductors can be exposed on the outside of a substrate to enable these fuses to be opened by the laser.

Turning to FIG. 2, disclosed is a system 200 for removing ESD protection from a single IO pad 201 by blowing a fuse 204 with a fuse blow control device 207. The system 200 comprises a processor 202. The processor 202 is coupled to an IO pad 201. The IO pad 201 is coupled to a current conducting path 203.

An ESD protection assembly 210 comprises a fuse 204, a fuse blow control device 207, and two diodes 205, 206. The anode of the first diode 205, the cathode of the second diode 206, and the fuse blow control device 207 are coupled to a node 208. The cathode of the first diode 205 is coupled to global Vdd 209. The anode of the second diode 206 is coupled to ground 211. The ESD protection assembly 210 is coupled to the IO pad 201 and processor 202 via the fuse 204. One end of the fuse 204 is coupled with the current conducting path 203. The other end of the fuse 204 is coupled with the node 208.

In the system 200, the diodes 205, 206 shield the IO pad 201 and processor 202 from significant variations in voltage. When the voltage difference between the IO pad 201 and ground 211 exceeds the activation voltage of the second diode 206 (the activation voltage of the second diode 206 will be exceeded when the ground 211 voltage exceeds the voltage at the IO pad 201 by around 0.6 volts), the second diode 206 becomes forward biased and creates a conducting path from ground 211 to the IO pad 201. Connecting the IO pad 201 to ground 211 protects the input coupled to the IO pad 201 by preventing the magnitude of the voltage difference between ground 211 and the IO pad 201 from exceeding the activation voltage of the second diode 206. Alternatively, when the voltage difference between the IO pad 201 and Vdd 209 exceeds the activation voltage of the first diode 205 (the activation voltage of the first diode 205 will be exceeded when the voltage at the IO pad 201 exceeds Vdd 209 by around 0.6 volts), the first diode 205 becomes forward biased and creates a conducting path from Vdd 209 to the IO pad 201. Connecting the IO pad 201 to Vdd 209 through the first diode 205 protects the input coupled to the IO pad 201 by preventing the magnitude of the voltage difference between Vdd 209 and the IO pad 201 from exceeding the activation voltage of the first diode 205.

In the system 200, the IO pad 201 and processor 202 can be electrically separated from the ESD protection assembly if a fuse 204 is blown using the fuse blow control device 207. The fuse blow control device 207 can comprise a processor product for decoupling the ESD protection assembly. The product can have a medium with a computer program thereon. The computer program can be responsible for applying a voltage to the IO pad 201, generating a current between the IO pad 201 and the fuse blow control device 207, and separating the IO pad 201 from the ESD protection assembly 210 as a function of the current between the IO pad 201 and control device 207.

In FIG. 2, the fuse blow control device 207 can comprise a field effect transistor. The fuse 204 is blown by applying a voltage to the IO pad 201. When a signal is received on a fuse blow control signal input 212, the fuse blow control device 207 shorts to ground 211. Thus, the voltage of the fuse blow control device 207 is at a different voltage than the voltage at the IO pad 201, but not so much different that the difference in voltages exceeds the activation voltage of either the first diode 205 or the second diode 206. No current flows through either the first diode 205 or the second diode 206 because it all flows through 203, 204, and 207 to ground 211, thereby creating current sufficient to blow the fuse 204. Blowing the fuse 204 decouples the processor 202 and IO pad 201 from the troublesome capacitance created by the ESD protection assembly 210.

Although the system 200 of FIG. 2 illustrates the invention using diodes and fuses, those of skill in the art understand that other elements are within the scope of the present invention.

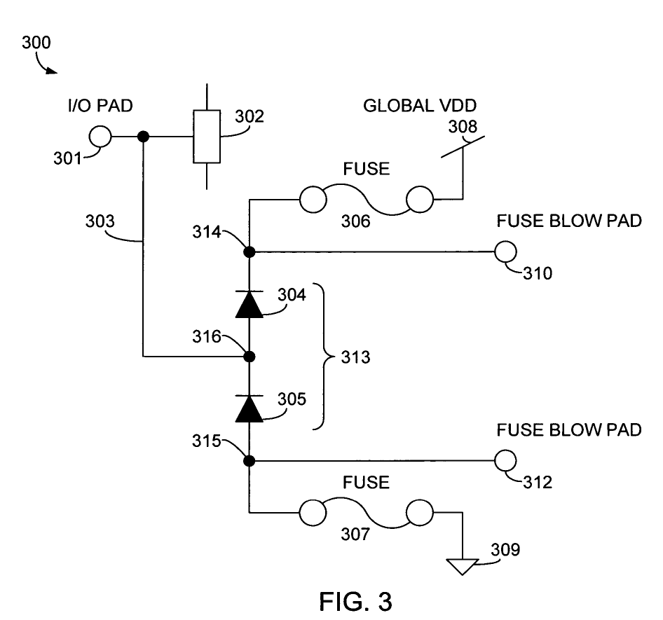

Turning to FIG. 3, disclosed is a system for removing ESD protection from a single IO pad 301 by blowing multiple fuses 306, 307. While involving more elements than the systems disclosed in FIGS. 1 and 2, this design can situate the fuses 306, 307 further from the processor 302. Situating the fuses 306, 307 further from the processor 302 can create a more controlled environment at the IO pad 301 when the fuses 306, 307 are blown.

The system 300 comprises a processor 302. The processor 302 is coupled to an IO pad 301. The IO pad is coupled to a current conducting path 303. The IO pad 301 and processor 302 may be electrically separated from a diode pair 313 if a first fuse 306 and a second fuse 307 are both blown.

A diode pair 313 comprises a first diode 304 and a second diode 305. The anode of the first diode 304 and the cathode of the second diode 305 are coupled to a node 316. The first node 316 is coupled to the first current conducting path 303. The cathode of the first diode 304 is coupled to a second node 314. The anode of the second diode 305 is coupled to a third node 315.

The second node 314 is coupled to a first fuse 306 and a fuse blow pad 310. The third node 315 is coupled to a second fuse 307 and a second fuse blow pad 312. One end of a first fuse 306 is coupled to the second node 314 and the other end of the first fuse 306 is coupled to global Vdd 308. One end of a second fuse 307 is coupled to the third node 315 and the other end of the second fuse 307 is coupled to ground 309.

In the system 300, the diodes 304, 305 shield the IO pad 301 and processor 302 from significant variations in voltage. When the voltage difference between the IO pad 301 and ground 309 exceeds the activation voltage of the second diode 305 (the activation voltage of the second diode 305 will be exceeded when the ground 309 voltage exceeds the voltage at the IO pad 301 by around 0.6 volts), the second diode 305 becomes forward biased and creates a conducting path from ground 309 to the IO pad 301. Connecting the IO pad 301 to ground 309 protects the input coupled to the IO pad 301 by preventing the magnitude of the voltage difference between ground 309 and the IO pad 301 from exceeding the activation voltage of the second diode 305. Alternatively, when the voltage difference between the IO pad 301 and Vdd 308 exceeds the activation voltage of the first diode 304 (the activation voltage of the first diode 304 will be exceeded when the voltage at the IO pad 301 exceeds Vdd 308 by around 0.6 volts), the first diode 304 becomes forward biased and creates a conducting path from Vdd 309 to the IO pad 301. Connecting the IO pad 301 to Vdd 309 through the first diode 304 protects the input coupled to the IO pad 301 by preventing the magnitude of the voltage difference between Vdd 309 and the IO pad 301 from exceeding the activation voltage of the first diode 304.

To separate the diode pair 313 from the IO pad 301 and processor 302, the first fuse 306 and the second fuse 307 are both blown. The first fuse 306 is blown by applying a voltage to the first fuse blow pad 310 that is sufficiently lower or greater than global Vdd 308. The second fuse 307 is blown by applying a voltage to the second fuse blow pad 312 that is sufficiently higher or lower than ground 309. Blowing the first fuse 306 and the second fuse 307 decouples the processor 302 and IO pad 301 from the troublesome capacitance created by the diode pair 313.

Although the system 300 of FIG. 3 illustrates the invention using diodes and fuses, those of skill in the art understand that other elements are within the scope of the present invention.

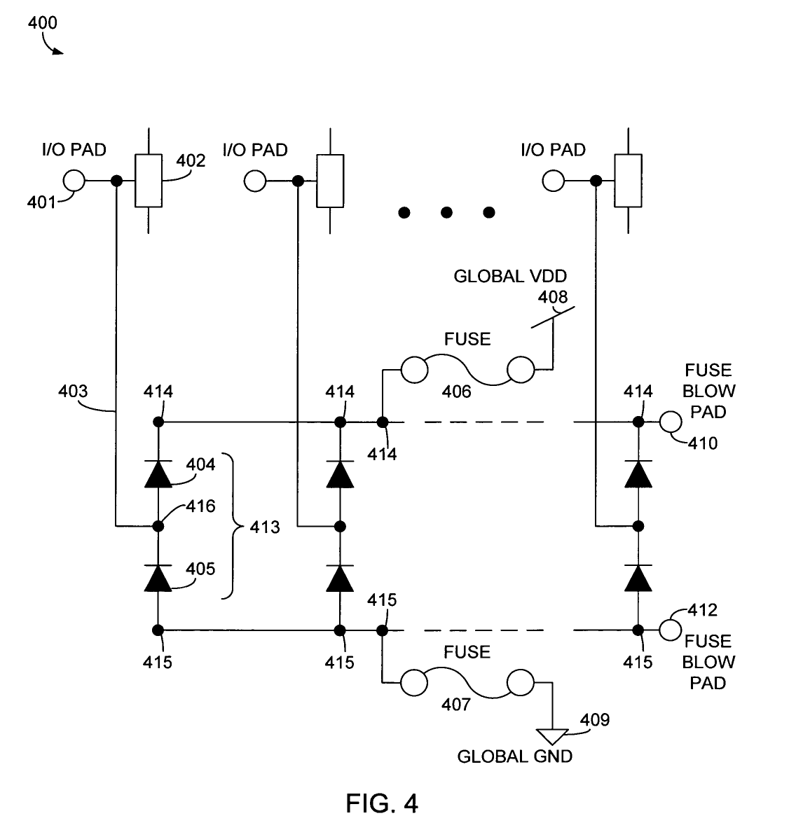

Turning to FIG. 4, disclosed is a system 400 for removing ESD protection from multiple IO pads 401 by blowing two fuses 406, 407. The system 400 comprises a plurality of IO pads 401, processors 402, and diode pairs 413.

The processor 402 is coupled to an IO pad 401. A current conducting path 403 is coupled to the IO pad 401. The IO pad 401 and processor 402 may be electrically separated from a diode pair 413 if a first fuse 406 and a second fuse 407 are both blown.

A diode pair 413 comprises a first diode 404 and a second diode 405. The anode of the first diode 404 and the cathode of the second diode 405 are coupled to a first node 416. The first node 416 is coupled to the current conducting path 403. The cathode of the first diode 404 is coupled to a second node 414. The anode of the second diode 405 is coupled to a third node 415.

In the system 400, the diodes 404, 405 shield the IO pad 401 and processor 402 from significant variations in voltage. When the voltage difference between the IO pad 401 and ground 409 exceeds the activation voltage of the second diode 405 (the activation voltage of the second diode 405 will be exceeded when the ground 409 voltage exceeds the voltage at the IO pad 401 by around 0.6 volts), the second diode 405 becomes forward biased and creates a conducting path from ground 409 to the IO pad 401. Connecting the IO pad 401 to ground 409 protects the input coupled to the IO pad 401 by preventing the magnitude of the voltage difference between ground 409 and the IO pad 401 from exceeding the activation voltage of the second diode 405. Alternatively, when the voltage difference between the IO pad 401 and Vdd 408 exceeds the activation voltage of the first diode 404 (the activation voltage of the first diode 404 will be exceeded when the voltage at the IO pad 401 exceeds Vdd 408 by around 0.6 volts), the first diode 404 becomes forward biased and creates a conducting path from Vdd 408 to the IO pad 401. Connecting the IO pad 401 to Vdd 408 through the first diode 404 protects the input coupled to the IO pad 401 by preventing the magnitude of the voltage difference between Vdd 408 and the IO pad 401 from exceeding the activation voltage of the first diode 404.

Each diode pair 413 can be decoupled from the IO pad 401 and processor 402 by means of the first fuse 406 and the second fuse 407. One end of the first fuse 406 is coupled to the second node 414. The other end of the first fuse 406 is coupled to global Vdd 408. One end of the second fuse 407 is coupled to the third node 415. The other end of the second fuse 407 is coupled to ground 409. The fuses are blown by a first fuse blow pad 410 coupled to the first node 414 and a second fuse blow pad 412 coupled to the third node 415.

To separate all of the diodes 404, 405 from all of the IO pads 401 and processors 402, the first fuse 406 and the second fuse 407 must be blown. The first fuse 406 is blown by applying a voltage to the first fuse blow pad 410 that is sufficiently lower or greater than global Vdd 408. The second fuse 407 is blown by applying a voltage to the second fuse blow pad 412 that is sufficiently higher or lower than ground 409. Blowing the fuses 406, 407 decouples the entire plurality of IO pads 401 and processors 402 from the troublesome capacitance created by the diode pairs 413.

Although the system 400 of FIG. 4 illustrates the invention using diodes and fuses, those of skill in the art understand that other elements are within the scope of the present invention.

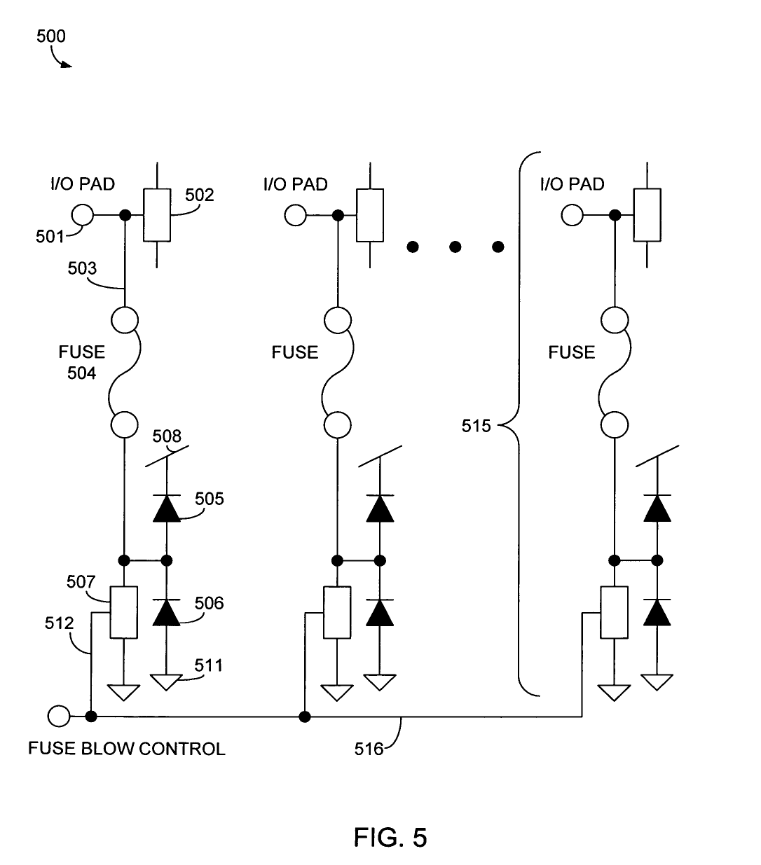

Turning to FIG. 5, disclosed is a system for removing ESD protection from multiple IO pads 501 by blowing a single fuse 504 per IO pad 501. The system 500 comprises a plurality of the systems described in FIG. 2 coupled through a common voltage pathway 516.

In this system 500, each of the plurality of systems 515 has a fuse blow control signal input 512. Each fuse blow control input 512 is coupled to a common voltage pathway 516. Thus, a single fuse blow control signal can blow each fuse 504. In all other ways, the system 500 functions as does the system described in FIG. 2. Thus, blowing the fuses 504 decouples the processors 502 and IO pads 501 from the troublesome capacitance created by the ESD protection.

In an further aspect of the system 100, the fuse 504 is commanded by its corresponding fuse control 507 to blow. However, another fuse in the system 500 is commanded not to blow by its corresponding fuse control 507. Blowing some fuses of the system 500 but not others can be used to allow for surge protection at a lower voltage. For instance, if the fuses were not all blown after assembly, the system 500 could be configured to blow for a 3 kilo-volt spike, instead of a 5 kilo-volt spike.

Although the system 500 of FIG. 5 illustrates the invention using diodes and fuses, those of skill in the art understand that other elements are within the scope of the present invention.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered desirable by those skilled in the art based upon a review of the foregoing description of preferred embodiments. Accordingly, it is appropriate that the appended claims be construed broadly and in a manner consistent with the scope of the invention.

1. A system for decoupling a capacitive path from an IO pad and a protected component, comprising:
a protected component;
an IO pad coupled to the protected component;
a source of current to the IO pad;
a first circuit which ceases to conduct after being exposed to a current that is directly connected to the IO pad and the protected component;
a second circuit able to cause the first circuit to cease conducting in response to variations in voltage or current; and
a capacitive path that is decoupled from the IO pad and protected component when the first circuit ceases to conduct.

2. The system of claim 1, wherein the protected component comprises a processor.

3. The system of claim 1, wherein the first circuit comprises a fuse.

4. The system of claim 1, wherein the second circuit comprises a fuse blow pad.

5. The system or claim 1, wherein:
the second circuit comprises a control signal input; and
the second circuit shorts to ground upon receipt of a control signal.

6. The system of claim 1, wherein the second circuit comprises a field-effect transistor.

7. The system of claim 1, wherein the capacitive path comprises:
a node coupled to the first circuit;
a first diode, the anode of which is coupled to the node; and
a second diode, the cathode of which is coupled to the node.

8. The system of claim 7, wherein the voltage coupled to the cathode of the first diode is a voltage other than a ground voltage.

9. The system of claim 7, wherein the voltage coupled to the anode of the second diode is a ground voltage.

10. The system of claim 7, wherein;
a first voltage is coupled to the IO pad;
a second voltage is coupled to the second circuit; and
the difference between the first voltage and the second voltage is less than the activation voltage of the first diode or the second diode.

11. The System of claim 7, wherein:
the second circuit has a control signal input;
the second circuit shorts to ground upon receipt of a control signal;
a voltage is coupled to the IO pad; and
the difference between the voltage coupled to the IO pad and the ground voltage is less than the activation voltage of the first diode or the second diode.

12. The system of claim 11, wherein a plurality of fuse blow control devices are connected to the same fuse blow control signal input.

13. A system for decoupling a capacitive path from an IO pad and a protected component comprising:
a protected component;
an IO paid coupled to the protected component;
a source of current to the IO pad;
a first Circuit which ceases to conduct when exposed to a current that is directly connected to the IO pad and the protected component;
a second circuit which ceases to conduct when exposed to a current;
a third circuit able to cause the fist circuit to cease conducting in response to variations in voltage;
a fourth circuit able to cause the second circuit to cease conducting in response to variations in voltage; and
a capacitive path that is decoupled from the IO pad and protected component when the first and second circuits cease conducting.

14. The System of claim 13, wherein the capacitive path comprises a diode pair, further comprising:
a first node;
a first diode, the anode of which is coupled to the first node;
a second diode, the cathode of which is coupled to the first node;
a second node coupled to the cathode of the first diode; and
a third node coupled to the anode of the second diode.

15. The System of claim 13, wherein the third circuit comprises a fuse blow pad.

16. The System of claim 13, wherein the fourth circuit comprises a fuse blow pad.

17. The System of claim 13, wherein the first circuit comprises a fuse.

18. The System of claim 13, wherein the second circuit comprises a fuse.

19. The System of claim 13, wherein a voltage is coupled to the third circuit.

20. The System of claim 13, wherein the voltage coupled to the fourth circuit is a voltage other than ground.

21. The System of claim 13, wherein a voltage is coupled to the first circuit.

22. The System of claim 13, wherein the voltage coupled to the second circuit is ground.

23. The system of claim 13, wherein:
a first voltage is coupled to first circuit;
a second voltage is coupled to the second circuit;
a third voltage is coupled to the third circuit;
a fourth voltage is coupled to the fourth circuit;
the difference of the first voltage and the third voltage causes the first circuit to cease conducting; and
the difference of the second voltage and the fourth voltage causes the second circuit to cease conducting.

24. The system of claim 13, further comprising:
a plurality of capacitive paths, IO pads, and protected elements, in which:
a capacitive path is coupled to an IO pad and protected element;
each capacitive path is coupled to the first circuit;
each capacitive path is coupled to the second circuit;
each capacitive path is coupled to the third circuit; and
each capacitive path is coupled to the fourth circuit.

25. The system of claim 24, in which:
a capacitive path comprises a diode pair;
the first node of a diode pair is coupled to an IO pad and a processor;
the second node of each diode pair is coupled to the first circuit;
the second node of each diode pair is coupled to the third circuit;
the third node of each diode pair is coupled to the second circuit; and
the third node of each diode pair is coupled to the fourth circuit.

26. A method for decoupling a capacitive path from an IO pad and a protected component, comprising:
applying a first voltage to an IO pad of a protected component;
generating a current between the IO pad and a control device; and
separating the IO pad and protected component from a capacitive path as a function of the current between the IO pad and the control device.

27. A computer program product for decoupling a capacitive path from an IO pad and a protected component, the computer program product having a medium with a computer program embodied thereon, the computer program comprising:
computer code for applying a first voltage to an IO pad of a protected component;
computer code for generating a current between the IO pad and a control device; and
computer code for separating the IO pad from a capacitive path as a function of the current between the IO pad and the control device.

28. A processor product for decoupling a capacitive path from an IO pad and a protected component, the product having a medium with a computer program embodied thereon, the computer program comprising:
computer code for applying a first voltage to an IO pad of a protected component;
computer code for generating a current between the IO pad and a control device; and
computer code for separating the IO pad from a capacitive path as a function of the current between the IO pad and the control device.

29. The system of claim 3, wherein the fuse is blown by a laser.

30. The system of claim 13, wherein the first circuit has ceased to conduct due to a signal generated by the third circuit, but the second circuit has not ceased to conduct.
